(19) United States
(12) Patent Application Publication
(10) Pub. No.: US 2018/0051547 A1
(43) Pub. Date: Feb. 22, 2018

(54) TRANSPORT AND ASSEMBLY RIGGING

(71) Applicant: Chickasaw Energy Solutions, LLC, Marietta, OK (US)

(72) Inventors: Stephen Kent Foster, Wilson, OK (US); James David Brown, JR., Ardmore, OK (US)

(21) Appl. No.: 15/243,286

(22) Filed: Aug. 22, 2016

(51) Int. Cl. E21B 43/34; B60P 3/24

(52) U.S. Cl. CPC E21B 43/34; B60P 3/24

(57) ABSTRACT

A transport apparatus for use in the oil and gas industry includes a separator with first and second supports connected thereto. The first and second supports will space the separator from a floor surface. One of the supports may include wheels so that the apparatus may be easily moved about an assembly facility. The apparatus, including the separator and the supports, is placed on the transport vehicle for transport to a desired site where it is positioned and connected to an inlet and transport lines.

### BACKGROUND

This disclosure is directed to a transport apparatus for use in the oil and gas industry. Specifically, this disclosure is directed to a transport apparatus for separators and other cylindrical vessels utilized in the oil and gas industry. Generally, separators used at collection and/or delivery sites for oil and gas are transported to the field with no or little external piping connected thereto. A water leg is at times connected to the separator, but otherwise external piping is generally not connected prior to placement of a separator at a desired site. Traditionally, a generally cylindrical vessel is delivered to the field and offloaded with a crane. A roustabout or other service company will stand the unit up with a crane or other lifting equipment. Once the separator has been positioned in the upright or vertical position, external piping is cut and the separator is assembled at the field location. The external piping is generally welded, bolted or threaded to the separator and may include, for example, gas, oil and water outlet pipes. Such piping is ultimately connected to transport lines for the oil, gas and/or water streams leaving the separator. The on-site assembly process requires extensive labor hours and, in some cases, creates a high safety risk due to the height of the separators.

### BRIEF DESCRIPTION OF THE DRAWINGS

FIG. 1 is a perspective view of the transport and rigging assembly of the current disclosure.

FIG. 2 is a side view of the apparatus of the current disclosure.

FIG. 3 is a view of the top end of the invention of the current disclosure.

FIG. 4 is a view of the bottom end.

FIG. 5 is a side view of the current invention positioned on a transport vehicle.

FIG. 6 is a schematic view showing the lifting operation for the invention of the current disclosure.

FIG. 7 is a view of the separator at a collection or other desired site.

FIG. 8 is a perspective view of a support for the separator.

FIG. 9 is a perspective view of an additional support.

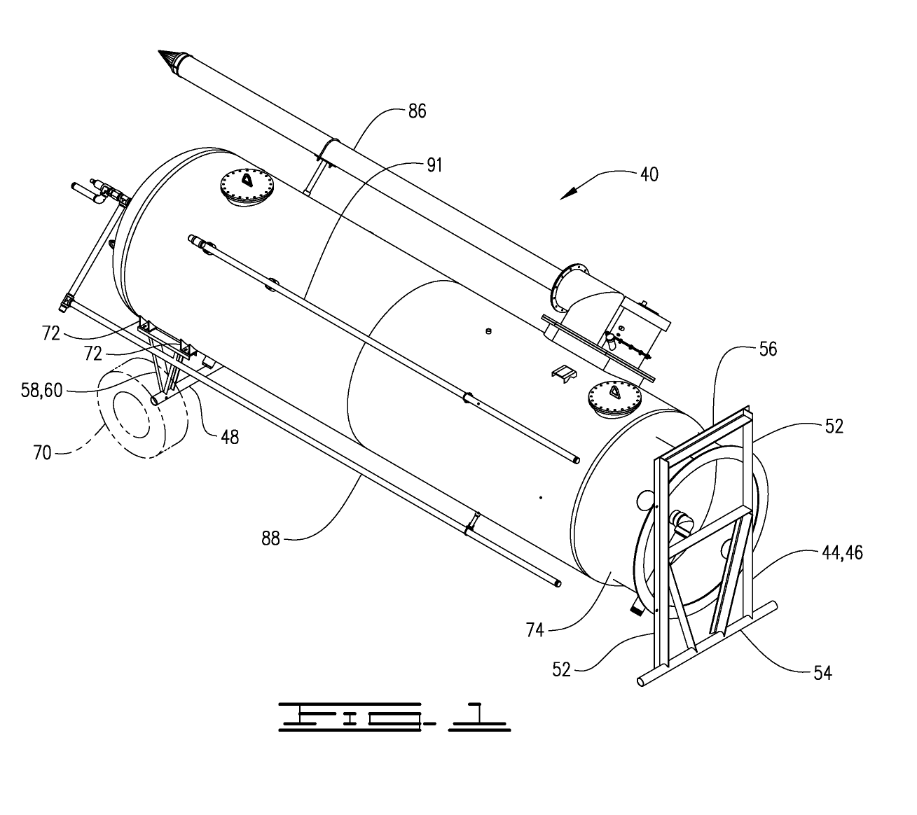

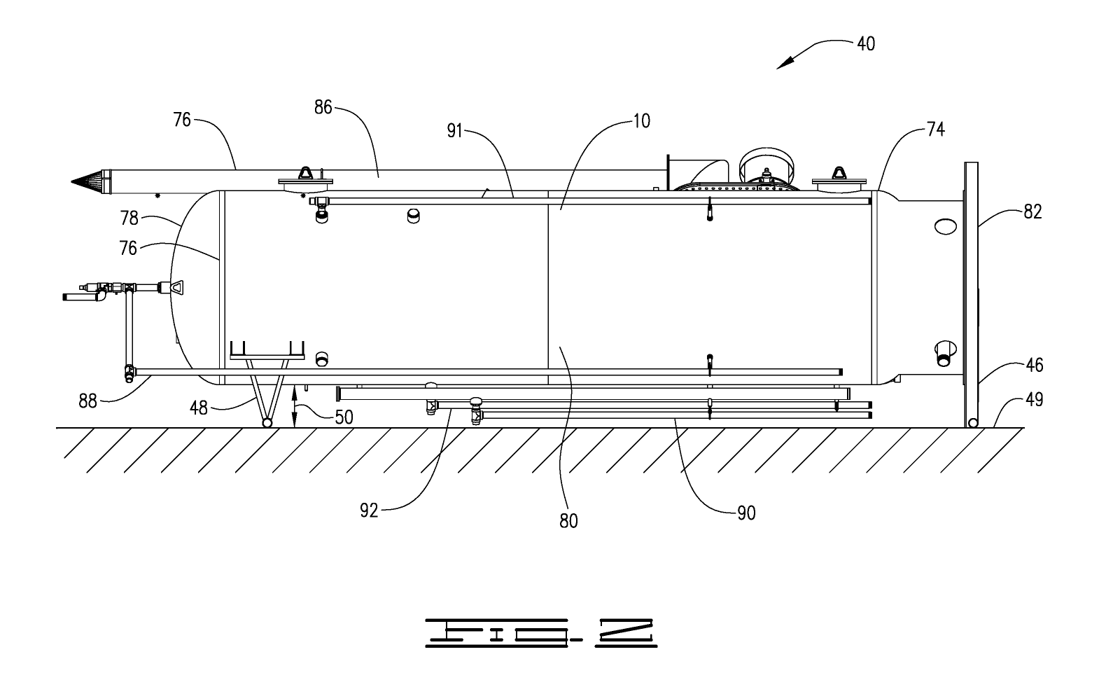

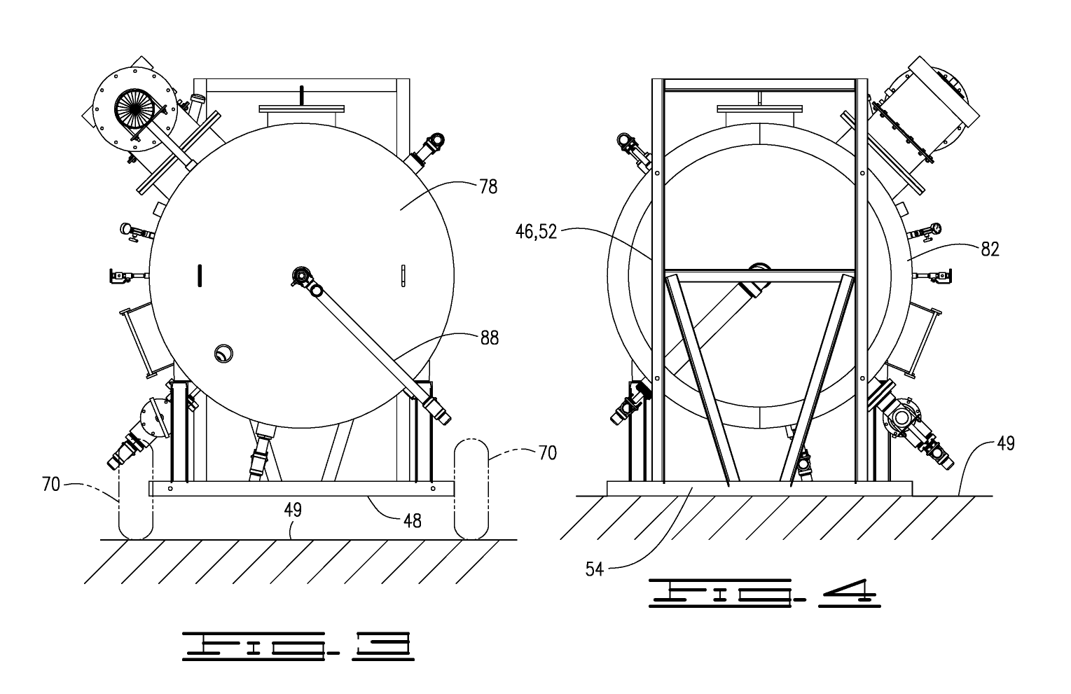

### SUMMARY OF THE INVENTION

The current disclosure is directed to an apparatus for transporting an oil and gas separator. The apparatus includes a plurality of supports, and in the current disclosure includes first and second supports. The first and second supports are configured to elevate the separator above a floor surface. One of the first and second supports may include a pair of wheels removably connected thereto. The wheels can engage an assembly floor surface so that the separator is movable in an assembly setting for easy assembly. The apparatus, including the first and second supports and the separator, can be lifted from a ground or floor surface to a transport vehicle and specifically to a transport floor surface. The first and second supports will space the separator from the transport floor surface. The apparatus may be secured to the transport vehicle with straps or other means known in the art.

The separator may include a cylindrical separator body, a top cap and a pedestal. External piping, such as a gas outlet pipe, a water outlet pipe and an oil outlet pipe may be connected to the cylindrical separator body. Likewise, a fire tube and an inlet pipe may be connected thereto. In the current disclosure, the external piping, or at least a part thereof, is connected to the cylindrical separator body prior to placement of the apparatus on the transport vehicle. Because the external piping is connected prior to placement on the transport vehicle and thus prior to ultimate placement at a desired site, assembly of the separator at the site is limited. Safety hazards are reduced as well since there is less need for assembly at locations where risk of fall or other injury may occur.

The method of the current disclosure may include connecting a top cap and pedestal to a cylindrical body. The method may further include connecting an oil outlet pipe, a gas outlet pipe and a water outlet pipe to the cylindrical body. An inlet pipe and a fire tube may also be connected to the cylindrical body. The method may further include connecting first and second supports to the separator body to space the separator from a floor surface. The apparatus including the first and second supports and the separator may be lifted to a transport vehicle, and specifically to a transport floor surface for transport to a desired site. Once transported to the desired site, the method may include lifting the apparatus from the transport vehicle and pivoting the separator about one of the first or second supports to an upright position. The first and second supports are removed prior to final placement at the desired site. The gas outlet, water outlet and oil outlet pipes may then be connected to transport lines at the site. The inlet pipe may likewise be connected to an inlet line to receive fluid to be separated.

### DESCRIPTION OF AN EMBODIMENT

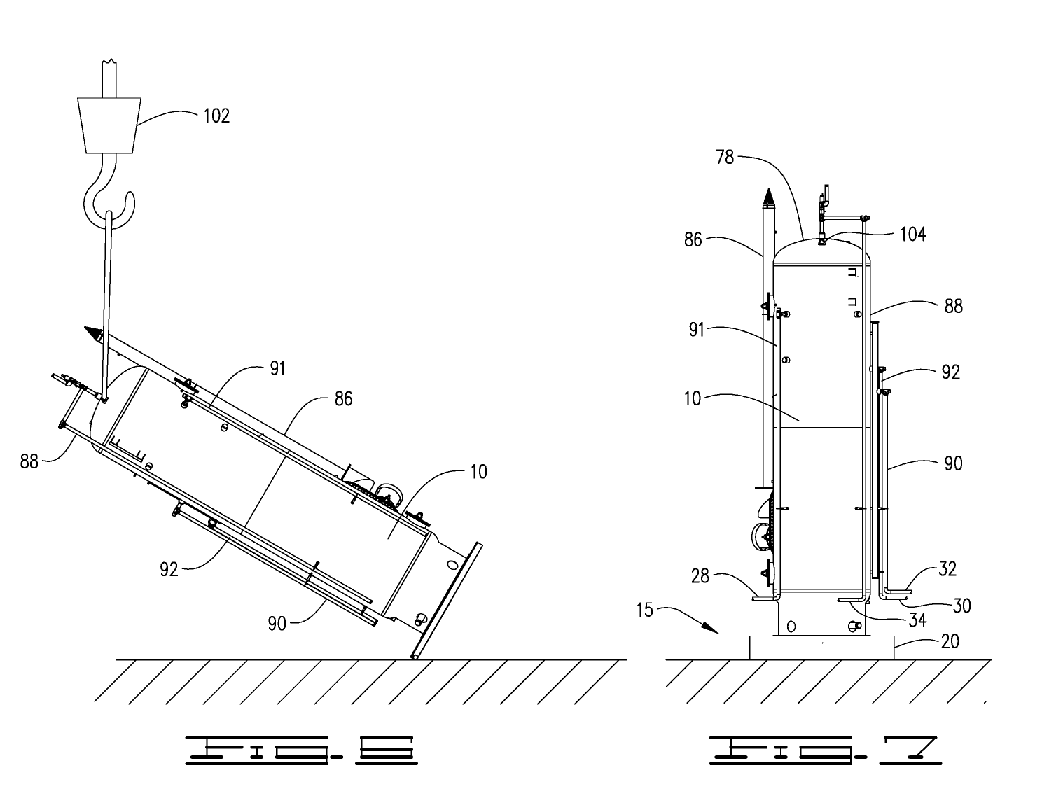

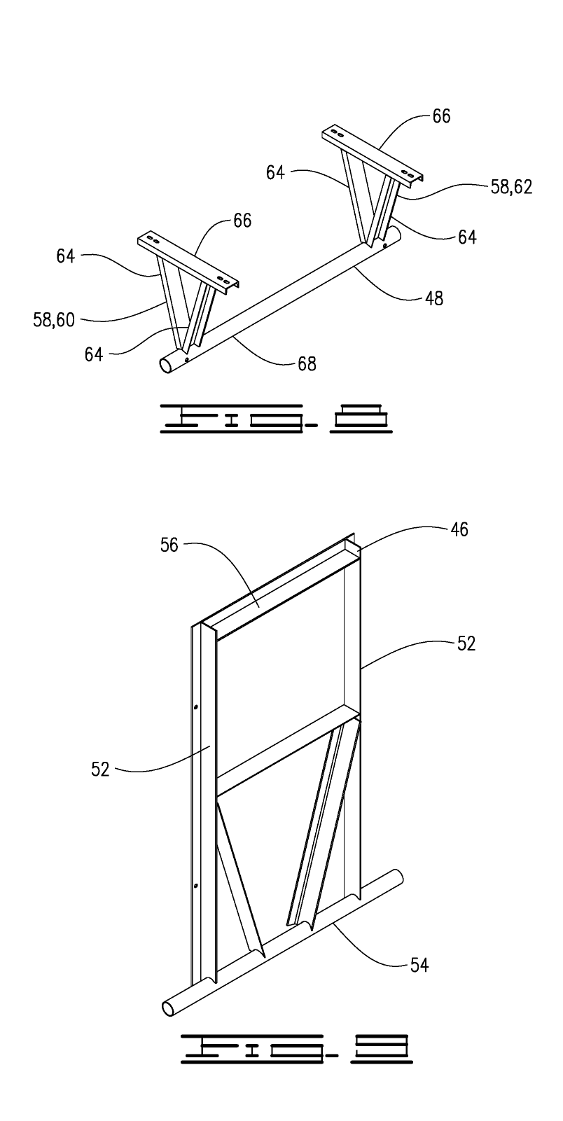

Referring to the drawings and particularly FIG. 7, a separator 10 is shown positioned at a collection site 15 on a cement or other pad 20. Fluid containing gas, oil and/or water will be received from an input line 28 that is connected to separator 10 at site 15. Separator 10 will separate the fluid into its component parts and will deliver water, oil and gas through a water outlet line 30, an oil outlet line 32 and a gas outlet line 34. The oil and gas will be delivered therethrough to a transportation line to be delivered to a customer, a large tank or other desired end location. Water will be transported for disposal or reuse.

Apparatus 40 disclosed herein comprises separator 10 and transport apparatus 42. Transport apparatus 42 comprises a plurality of supports 44, which may include a first or lower support 46 and second or upper support 48. While the current disclosure is directed to an embodiment with two supports, it is understood that more than two supports 44 may be utilized if the size of the separator is such that more than two supports are needed. First and second supports 46 and 48, when connected to separator 10, elevate separator 10 above a ground or support surface 49. Thus, a space 50 will exist between separator 10 and support surface 49. First support 46 comprises a pair of upright beams 52, which may be spaced vertical beams 52. A horizontal cross brace 54 is positioned at a bottom or lower end of first support 46 and an upper or second horizontal cross brace 56 is connected to spaced vertical beams 52 at the upper end thereof Lower horizontal cross brace 54 will engage the ground surface and, as will be described in more detail herein, may be utilized to pivot the separator 10 to an upright position at the site 15. Cross brace 54 helps to maintain the balance of separator 10 as it is pivoted to the upright position, and thus prevents damage to the separator 10.

Second support 48 comprises a pair of spaced apart support frames 58. Support frames 58 comprise first and second support frames 60 and 62. Each of frames 60 and 62 are generally triangularly shaped support frames with support legs 64 and a base 66. A horizontal brace 68 is connected to each of first and second support frames 60 and 62. Horizontal brace 68 comprises an axle to which a pair of wheels 70 may be connected. Connection brackets 72 are fixed in a manner known in the art to the separator 10 and second support 48 is connected to brackets 72 with bolts such that support 48 is removably connected to separator 10. Wheels 70 are utilized to move separator 10 throughout an assembly facility for the purpose of connecting external piping thereto. As will be explained in more detail, this provides for easier assembly at the assembly site, and easier, more efficient installation at site 15. Wheels 70 provide for easy movement throughout an assembly facility by simply lifting an end 74 of separator 10 with first support 46 and pulling separator 10 along a floor surface 49 at the assembly site.

Separator 40 has first or lower end 74 and second or upper end 76. A top cap 78 is located at the upper end 76 thereof. In addition to top cap 78, separator 10 includes cylindrical body 80 and a pedestal 82 at the lower end 74 thereof. Top cap 78, cylindrical body 80 and pedestal 82 are fixed to one another by welding or other means known in the art. First support 46 is bolted to pedestal 80 and is therefore removably connected to separator 10. Second support 48 is bolted to brackets 72 and is likewise removably connected to separator 10.

Separator 10 may include external piping which may be, for example, a fire tube 86, a gas outlet pipe 88, water outlet pipe 90 an oil outlet pipe 92. An inlet pipe 91 is also connected to cylindrical separator body 80, and will receive fluid for separation. Water outlet pipe may be connected to a water leg 89.

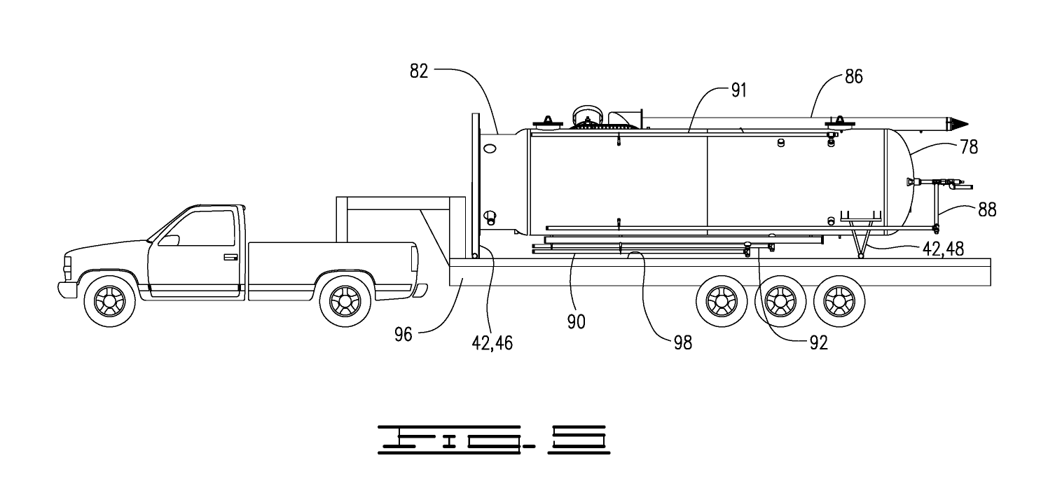

Separator 10, with external piping 84 attached thereto, may be lifted to a transport vehicle 96 as shown in FIG. 5 and placed on a transport floor surface 98 thereof. Wheels 70 are removed prior to positioning the apparatus 40 on transport vehicle 96. As described above, supports 46 and 48 elevate the separator 10 a space 50 above a support surface, which in this case is the transport floor surface 98. As a result, connected piping, such as gas outlet pipe 88, oil outlet pipe 92, water outlet pipe 90 and inlet pipe 91 are spaced from transport floor surface 98, and will not be contacted by straps or other means used to fix separator 10 to the transport vehicle. Apparatus 40 is fixed to the transport floor surface 98 by utilizing straps and other fixtures known in the art, which may be connected to first and second supports 46 and 48. In normal transport of a separator without the use of transport apparatus 42, straps and other means are placed directly on the separator, which prevents the connection of the external piping as described herein. As a result, external piping 84 must in that case be connected at the site 15.

Once apparatus 40 is delivered to the collection site, a crane or other lifting apparatus 102 is utilized to lift the apparatus 40 utilizing a lifting ring 104 that is fixed by welding or otherwise to separator 10. Second support 48 is removed prior to final placement at the site. A strap 100 or other means of connecting to crane 102 is utilized. Apparatus 40 is lifted from the transport floor surface 98 and delivered to pad 20 or other desired location at collection site 15. Apparatus 40 may be placed on pad 20 and specifically, horizontal brace 54 of first support 46 may be positioned thereon and used as a pivot or rotation point. Once horizontal brace 54 is engaged on the ground surface, crane 102 can lift the upper end of separator 10 to lift and pivot about brace 54 until the separator 10 is in the upright position. At that point, separator 10 may be lifted directly upwardly and the brace 46 unbolted.

Once separator 10 is positioned on pad 20, it may be fixed thereto by means known in the art. An inlet line 28 may be connected to inlet pipe 91, and water, oil and gas lines 32, 30 and 34 may then be directly connected to the water, oil and gas outlet pipes 90, 92 and 88, all of which were connected to cylindrical separator body 80 prior to being placed on the transport vehicle 96.

Because separator 10 is fully or nearly fully assembled and includes external piping, including inlet pipe 91, gas, oil and water outlet pipes 88, 92 and 90 and a fire tube 86 connected thereto prior to placement at the site 15, assembly time at the site 15 is decreased and safety hazards are likewise eliminated.

The method of assembling and transporting may include connecting the top cap 78, cylindrical body 80 and pedestal 82, and mounting first and second supports 46 and 48 thereto. Apparatus 40 may be moved through an assembly facility to attach, for example, a fire tube 86, an inlet pipe 91, a gas outlet pipe 88, an oil outlet pipe 92 and a water outlet pipe 90. A ladder and other external fixtures may likewise be connected during the assembly process. Apparatus 40, which includes transport apparatus or assembly 42 and separator 10 may then be lifted and placed upon transport floor surface 98. Wheels 70 are preferably removed prior to placing apparatus 40 on transport floor surface 98. Separator 10 is lifted from the transport vehicle utilizing apparatus 10. First support 46, and specifically horizontal cross brace 54 may be used as a pivot for pivoting or rotating the separator 10 into the vertical position. Apparatus 102 is utilized to pivot the apparatus 40 utilizing a lifting ring 104. Once in the vertical position, the method may comprise removing the second support 46 and mounting separator 10 to the desired site and connecting separator 10 to an input line. The method may further comprise connecting the external piping, including gas outlet pipe 88, oil outlet pipe 92 and water outlet pipe 90 to transport lines for each at the site 15. For example, gas outlet pipe 88 may be connected to a transport line 34, oil outlet pipe 92 connected to a transport line 30, and water outlet pipe connected to a line 32. Inlet pipe 91 may be connected to an inlet line 28 to receive fluid to be separated.

Thus, it is seen that the apparatus and methods of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art, which changes are encompassed within the scope and spirit of the present invention.

What is claimed is:

1. Apparatus for transporting an oil and gas separator comprising:
a first support mounted to the separator, the first support configured to elevate a first end of the separator above a floor surface;
a second support mounted to the separator, the second support configured to elevate a second end of the separator above the floor surface;
a pair of wheels removably connected to at least one of the first and second supports for engaging the floor surface, the separator being moveable from the floor surface to a transport vehicle surface with the first and second supports attached thereto.

2. The apparatus of claim 1, wherein the wheels are removed prior to the separator being moved to the transport vehicle surface.

3. The apparatus of claim 1, the separator comprising:
a generally cylindrical separator body;
a top cap connected at a first end of the cylindrical separator body;
a pedestal connected at a second end of the cylindrical separator body; and
external piping connected to the cylindrical separator body.

4. The apparatus of claim 3, wherein the external piping comprises a gas outlet pipe and an oil outlet pipe.

5. The apparatus of claim 4, the external piping further comprising a fire tube and an inlet pipe for receiving fluid to be separated.

6. The apparatus of claim 3, wherein a space between the transport floor and the cylindrical body is such that external piping may be positioned therein.

7. The apparatus of claim 1, wherein the separator will pivot about one of the first and second supports to an upright position.

8. An apparatus for assembling and transporting a separator comprising:
first and second supports connected to the separator, the first and second supports configured to elevate the separator above a floor surface;
wherein the separator comprises external piping connected to a cylindrical body, and wherein the separator is moveable from a floor surface to a transport vehicle with the external piping connected to the cylindrical body.

9. The apparatus of claim 8, wherein the external piping comprises at least an oil outlet pipe and a gas outlet pipe.

10. The apparatus of claim 8, the separator comprising the cylindrical body, a top cap at the first end of the cylindrical body and a pedestal at a second end thereof.

11. The apparatus of claim 10, wherein the first support comprises:
spaced braces connected to the cylindrical body;
a horizontal beam connected to the spaced braces; and
a pair of wheels removably connected to the horizontal beam.

12. The apparatus of claim 10, wherein the wheels are removed prior to placement on the transport vehicle.

13. The apparatus of claim 8, wherein the separator is fixed to the transport vehicle with the first and second supports.

14. The apparatus of claim 8 wherein the first support is removably connected to the pedestal.

15. A method of transporting an oil and gas separator comprising:
connecting supports to the separator to space the separator from a ground surface;
moving the separator with the supports attached thereto to a transport vehicle; and
attaching the separator to the transport vehicle with the supports.

16. The method of claim 15, wherein the separator comprises a cylindrical body, a top cap and a pedestal, the method further comprising connecting external piping to the cylindrical body prior to the moving step.

17. The method of claim 16 wherein the external piping comprises a gas outlet pipe and an oil outlet pipe.

18. The method of claim 14, further comprising:
disconnecting the supports from the transport vehicle;
lifting the separator from the transport vehicle;
positioning the separator at a desired location; and
connecting the separator to a fluid input line.

19. The method of claim 18, wherein the first support is connected to the pedestal, the method comprising pivoting the separator about the first support to an upright position; and
removing the first and second supports prior to placing the separator at the desired location.

20. The method of claim 19 wherein the separator comprises a cylindrical body, a top cap, a pedestal, a gas outlet pipe, an oil outlet pipe, and a fire tube connected to the cylindrical body.
